(19) United States
(12) Patent Application Publication
(10) Pub. No.: US 2025/0335318 A1
(43) Pub. Date: Oct. 30, 2025

(54) METHOD, DEVICE, AND COMPUTER PROGRAM PRODUCT FOR FILE SYSTEM RECOVERY

(71) Applicant: Dell Products L.P., Round Rock, TX (US)

(72) Inventors: Shuning Zhang, Beijing (CN); Lei Gao, Beijing (CN); Huan Chen, Beijing (CN); Ming Zhang, Beijing (CN); Chen Gong, Beijing (CN)

(21) Appl. No.: 18/928,373

(22) Filed: Oct. 28, 2024

(30) Foreign Application Priority Data
Apr. 26, 2024 (CN) 202410511179.0

(51) Int. Cl. G06F 11/20

(52) U.S. Cl. CPC G06F 11/2023; G06F 11/2082

(57) ABSTRACT

Techniques for file system recovery involve: running a recovery task for a file system on a first node, and synchronizing task data associated with the recovery task in a memory of the first node to a memory of a second node during the running of the recovery task. Data of the file system is stored in a storage device that is accessible via the first or second node. Such techniques further involve: in response to the recovery task panicking on the first node, resuming the running of the recovery task on the first node by using the task data that has been synchronized to the memory of the second node. Accordingly, the recovery task for the file system can continue even if some problems are encountered without re-running from the beginning.

### CROSS-REFERENCE TO RELATED APPLICATION

This application claims priority to Chinese Patent Application No. CN202410511179.0, on file at the China National Intellectual Property Administration (CNIPA), having a filing date of Apr. 26, 2024, and having “FILE SYSTEM RECOVERY METHOD, DEVICE AND COMPUTER PROGRAM PRODUCT” as a title, the contents and teachings of which are herein incorporated by reference in their entirety.

### TECHNICAL FIELD

Embodiments of the present disclosure relate to storage technologies, and more specifically, relate to a method, a device, and a computer program product for file system recovery.

### BACKGROUND

In a storage system, in order to ensure the availability of data, underlying data in storage devices (e.g., disks, solid state drives, and arrays thereof) is often shared by two or more nodes. In this way, the data in the storage devices is accessible via any of the nodes, so that when one node fails, the data is still accessible via the other nodes.

Each node of the storage system may have its own processor. For example, when a request for data in a storage device is received, a node can use a file system to locate and access the requested data. A file system is a method and data structure used by an operating system for files on a storage device or partition, and it organizes data into a hierarchy of logical units and establishes mappings between the logical units and physical storage locations.

For example, indexes of data corresponding to logical unit numbers (LUNs) can be organized into a tree of index pages, and can be layered from top to bottom into a top IDP (index data page), a middle IDP, a leaf IDP, and a virtual logical block (VLB). The relationships between these index pages may be damaged for some reasons, such that corresponding data accesses are affected. In this case, the storage system can run a recovery task (for example, file system consistency check (FSCK)) for a file system to try to recover the relationships between these pages.

### SUMMARY OF THE INVENTION

Embodiments of the present disclosure provide a solution for file system recovery.

In a first aspect of the present disclosure, there is provided a file system recovery method including: running a recovery task for a file system on a first node, wherein data of the file system is stored in a storage device that is accessible via the first node or a second node; synchronizing task data associated with the recovery task in a memory of the first node to a memory of the second node during the running of the recovery task; and in response to the recovery task panicking on the first node, resuming the running of the recovery task on the first node by using the task data that has been synchronized to the memory of the second node.

In a second aspect of the present disclosure, there is provided an electronic device including a processor and a memory coupled to the processor, wherein the memory has instructions stored therein, and the instructions, when executed by the processor, cause the device to perform actions including: running a recovery task for a file system on a first node, wherein data of the file system is stored in a storage device that is accessible via the first node or a second node; synchronizing task data associated with the recovery task in a memory of the first node to a memory of the second node during the running of the recovery task; and in response to the recovery task panicking on the first node, resuming the running of the recovery task on the first node by using the task data that has been synchronized to the memory of the second node.

In a third aspect of the present disclosure, there is provided a computer program product that is tangibly stored on a computer-readable medium and includes machine-executable instructions that, when executed, cause a machine to perform the method according to the first aspect of the present disclosure.

It should be noted that the SUMMARY OF THE INVENTION is provided to introduce a selection of concepts in a simplified manner, and these concepts will be further described in the Detailed Description below. The SUMMARY OF THE INVENTION is neither intended to identify key features or major features of the present disclosure, nor intended to limit the scope of the present disclosure.

### BRIEF DESCRIPTION OF THE DRAWINGS

The above and other objectives, features, and advantages of the present disclosure will become more apparent by description of example embodiments of the present disclosure in more detail with reference to the drawings in which:

FIG. 1 shows a schematic diagram of an example environment in which a plurality of embodiments of the present disclosure can be implemented;

FIG. 2 shows an example file system recovery method according to some embodiments of the present disclosure;

FIG. 3 shows an example schematic diagram of synchronizing recovery task data in multiple stages according to some embodiments of the present disclosure;

FIG. 4A shows an example schematic diagram of encoding and decoding processes when recovery task data is synchronized according to some embodiments of the present disclosure;

FIG. 4B shows an example schematic diagram of encoding and decoding processes when a recovery task is resumed according to embodiments of the present disclosure;

FIGS. 5A-5C show binary-encoded structures of an example data type according to some embodiments of the present disclosure; and

FIG. 6 shows a schematic block diagram of a device that can be used to implement embodiments of the present disclosure.

In the entire drawings, the same or similar reference numerals represent the same or similar elements.

### DETAILED DESCRIPTION

The individual features of the various embodiments, examples, and implementations disclosed within this document can be combined in any desired manner that makes technological sense. Furthermore, the individual features are hereby combined in this manner to form all possible combinations, permutations and variants except to the extent that such combinations, permutations and/or variants have been explicitly excluded or are impractical. Support for such combinations, permutations and variants is considered to exist within this document.

It should be understood that the specialized circuitry that performs one or more of the various operations disclosed herein may be formed by one or more processors operating in accordance with specialized instructions persistently stored in memory. Such components may be arranged in a variety of ways such as tightly coupled with each other (e.g., where the components electronically communicate over a computer bus), distributed among different locations (e.g., where the components electronically communicate over a computer network), combinations thereof, and so on.

Embodiments of the present disclosure will be described below in further detail with reference to the drawings. Although the drawings show some embodiments of the present disclosure, it should be understood that the present disclosure may be implemented in various forms, and should not be explained as being limited to the embodiments stated herein. Rather, these embodiments are provided for understanding the present disclosure more thoroughly and completely. It should be understood that the drawings and embodiments of the present disclosure are for illustrative purposes only, and are not intended to limit the scope of protection of the present disclosure.

The term “include” and variants thereof used herein mean open-ended inclusion, i.e., “including but not limited to.” The term “based on” is “based at least in part on.” The term “one embodiment” means “at least one embodiment.” The term “another embodiment” indicates “at least one additional embodiment.” Relevant definitions of other terms will be given in the description below.

A file system includes metadata for data in a storage device. It organizes the data in the storage device into a hierarchy of logical units and establishes mappings between the logical units and physical storage locations in the storage device so that the data in storage device can be accessed correctly. When some metadata corruptions exist in the file system, there is a need to run a recovery task for the file system, such as an FSCK or another recovery task depending on implementations.

The recovery task will modify metadata shared by a plurality of nodes. In order to avoid data conflicts caused by simultaneous recovery of a plurality of nodes, in a conventional design, when a storage system enters a recovery mode to try to recover its file system, the recovery task will run on one node while the remaining nodes will be shut down. Therefore, during the recovery task, the storage system will enter the recovery mode such that data stored therein is unavailable.

During the running of the recovery task, a large number of index structures (e.g., IDP trees, PageBin trees, etc.) are scanned to gather necessary information for subsequent operations. The information is stored in a memory of a device on which the recovery task runs (for example, a certain node in the storage system) for use by corresponding processes. For example, when an FSCK attempts to recover relationships in metadata, an entire metadata layer (including an IDP tree structure) and a VLB layer of a file system is scanned, and scanned error-related information is recorded in the memory. The FSCK then attempts to recover error indexes based on the information recorded in the memory. This process is time-consuming and often runs for hours or even days.

During the running of the recovery task, any abnormal/unexpected code defects can cause the recovery task to panic. In addition, there are other anomalies that may cause the recovery task to panic, such as hardware errors, misoperations, and so on. On the other hand, the data on which the recovery task depends is mainly stored in a memory of an execution node. Due to the volatility of the memory, when the recovery process panics, the data in the memory will be lost, so that the recovery task needs to run from the beginning. In this way, time-consuming operations need to be performed again. This will take several hours or several days again. Therefore, if the recovery task fails/panics during running, the unavailable time of data associated with the file system will increase dramatically.

To at least partially address the above and other potential problems, embodiments of the present disclosure propose a solution for file system recovery. In this solution, a recovery task for a file system will run collaboratively on two nodes in different modes. When the storage system enters a recovery mode, the two nodes start. One of the two nodes acts as an active node to run the recovery task for the file system to try to recover system metadata. During the running of the recovery task, task data associated with the recovery task in a memory of the active node is synchronized to a memory of the other node that acts as a standby node.

And then, if the recovery task panics on the active node, the recovery task can be resumed to run on the active node by using the task data that has been synchronized to the memory of the standby node. This allows the recovery task for the file system to continue even if some problems are encountered without re-running from the beginning. Such a solution according to embodiments of the present disclosure can therefore reduce the unavailable time of data of the storage system in the recovery mode, thereby improving user experiences.

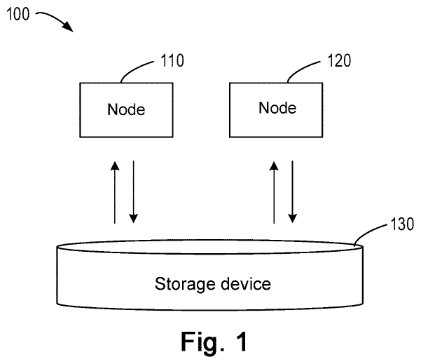

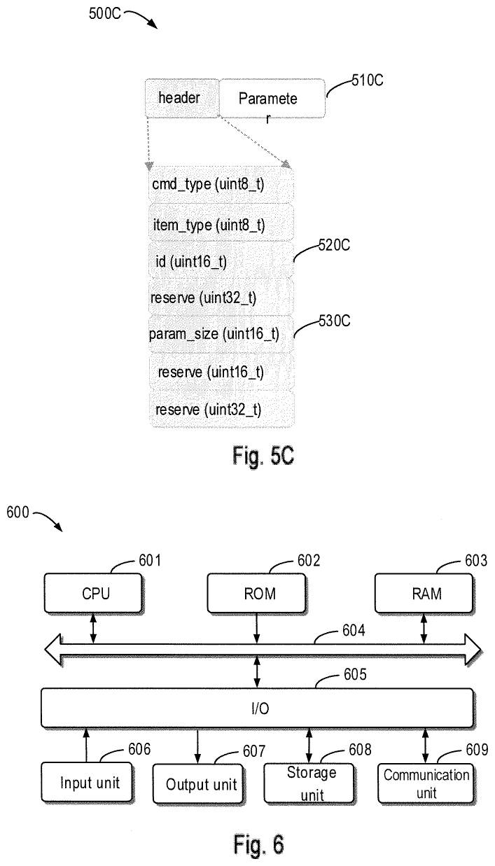

FIG. 1 shows a schematic diagram of an example environment 100 in which a plurality of embodiments of the present disclosure can be implemented. The environment 100 includes two nodes of the same storage system, i.e., a node 110 and a node 120. It should be understood that, for example, in order to accommodate the requirements of high throughput and the like, in some embodiments, the storage system may further have additional nodes. The embodiments of the present disclosure do not limit the total number of nodes of the storage system. The nodes 110 and 120 can each be implemented as an electronic device as will be described in more detail below with reference to FIG. 6. Each node has its own relevant computing resources, such as processing and memories, to process data access operations and other operations for the storage system, such as file system recovery operations.

The nodes 110 and 120 share a physical storage device 130 of the storage system. In other words, data in the storage device 130 can be accessed via either the node 110 or the node 120. The nodes 110 and/or 120 can dump write requested data to the storage device 130 and/or read data from the storage device 130. The storage device 130 can be implemented using any known or future developed storage technologies, such as redundant arrays of independent disks (RAID).

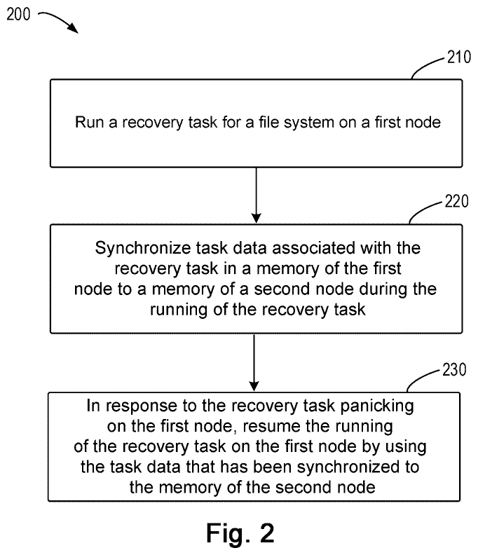

The data in the storage device 130 is organized into a corresponding file system for the nodes 110 and 120 to access. Based on index structures and file metadata in the file system, the nodes 110 and 120 can locate corresponding data in the storage device 130. In some cases, metadata and the like in the file system may be corrupted. To ensure that data can be accessed properly, the storage system needs to run a recovery task for the file system. In some embodiments of the present disclosure, the node 110 and/or the node 120 may act as an active node and a standby node respectively to run the recovery task collaboratively. More detailed description will be made below with reference to FIGS. 2-5.

For ease of description, some embodiments of the present disclosure will be described below by taking the node 110 as an active node and a control node. It should be understood that in such a context, when it is mentioned that the node 110 performs an action on the node 120, it means that the node 110 causes the node 120 to perform a corresponding action since the node 110 communicates with the node 120 (for example, sending data or instructions to the node 120), that is, the node 120 performs an action in response to a communication with the node 110.

The architecture and functions in the example environment 100 are described for illustrative purposes only, without implying any limitation to the scope of the present disclosure. There may also be other devices, systems, or components that are not shown in the example environment 100. For example, the environment 100 can further include a terminal device. Users can send data read and write requests to the storage system node via the terminal device. For example, a separate control node may also be included in the environment 100 to send instructions to other nodes to coordinate operations of each node, such as a file system recovery task running on two nodes according to embodiments of the present disclosure. In such embodiments, the actions in the embodiments of the present disclosure may be deemed to be performed by the control node.

FIG. 2 shows a flow chart of an example file system recovery method 200 according to some embodiments of the present disclosure. The example method 200 may be performed, for example, by the node shown in FIG. 1. It should be understood that the method 200 may also include additional actions not shown, and the scope of the present disclosure is not limited in this regard. The method 200 will be described in detail below in conjunction with the example environment 100 in FIG. 1.

At 210, a recovery task for a file system runs on a first node, where data of the file system is stored in a storage device that is accessible via the first node or a second node. For example, the node 110 can run a recovery task (e.g., FSCK) for a file system thereon, where data corresponding to the file system is stored in the storage device 130. As shown in FIG. 1, the storage device 130 is accessible via any of the nodes 110 and 120.

For example, in response to receiving a file system recovery instruction from a user, the node 110 can start a process of the recovery task for the file system. At this point, the storage system where the nodes 110 and 120 reside enters a recovery mode, so that the data in the storage device 130 is inaccessible temporarily. During the recovery task, the node 110 can scan an index structure of the file system to collect task data needed for subsequent actions, such as scanned metadata errors and other information needed to recovery errors. The collected data and possible other task data generated during the recovery task are then stored in a memory space of the node 110.

At 220, task data associated with the recovery task in a memory of the first node is synchronized to a memory of the second node during the running of the recovery task. For example, during the running of the recovery task, the node 110 can synchronize task data associated with the recovery task in a memory thereof to a memory of the node 120.

In some embodiments, when the node 110 starts the recovery task, the node 120 can start a process of a corresponding standby task. The standby task is used to synchronize the task data associated with the recovery task in the memory of the node 110 to the node 120. And then, the node 110 sends the task data to the node 120 during the recovery task, and the node 120 receives the task data from the node 110 via the standby task. The node 120 then stores the received task data at a corresponding location in its memory via the standby task.

For example, in one example implementation, the recovery task and the standby task can be implemented as two modes of the recovery task for the file system. The node 110 runs the recovery task in an active mode. In the active mode, the recovery task attempts to recover the file system of data in the storage device 130.

On the other hand, the node 120 runs the process of the recovery task in a standby mode. In the standby mode, the recovery task does not attempt to recover the same file system to avoid conflicts or errors. Instead, via the recovery task in the standby mode, the node 120 communicates with the node 110 to synchronize the task data associated with the recovery task in the memory of the node 110 to the memory of the node 120 for storage. Thus, each node has a memory copy of the task data.

At 230, in response to the recovery task panicking on the first node, the running of the recovery task is resumed on the first node by using the task data that has been synchronized to the memory of the second node. For example, in response to the recovery task on the node 110 (a process terminates, a node goes down or fails in other manners), the node 110 can resume the running of the recovery task on the node 110 by using the task data that has been synchronized to the memory of the second node.

As known to those skilled in the art, if the recovery task on the node 110 panics, the task data stored in the memory of the node 110 will be lost. At this point, since the copy of the task data is held in the memory of the node 120, the node 110 can obtain the copy from the node 120 to restore the memory state of the node 110. This allows the node 110 to continue to run the recovery task in the resumed memory state.

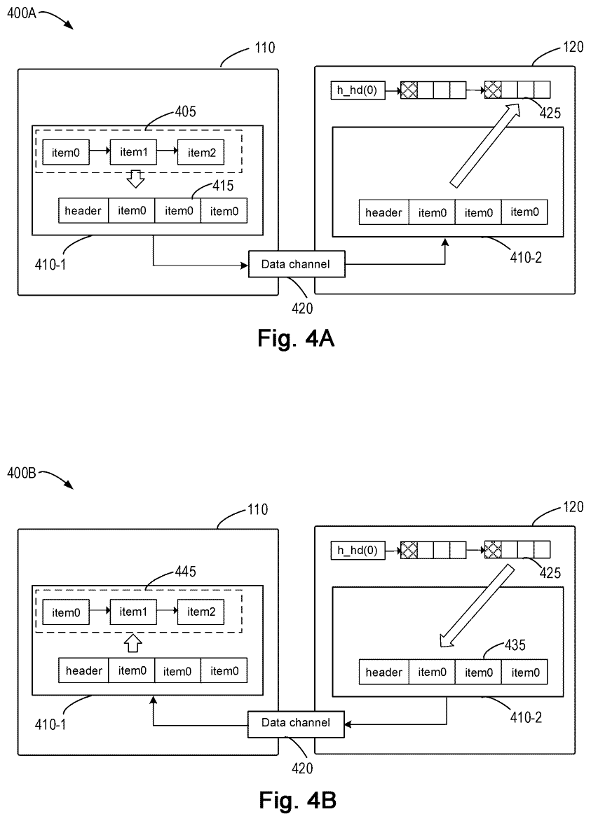

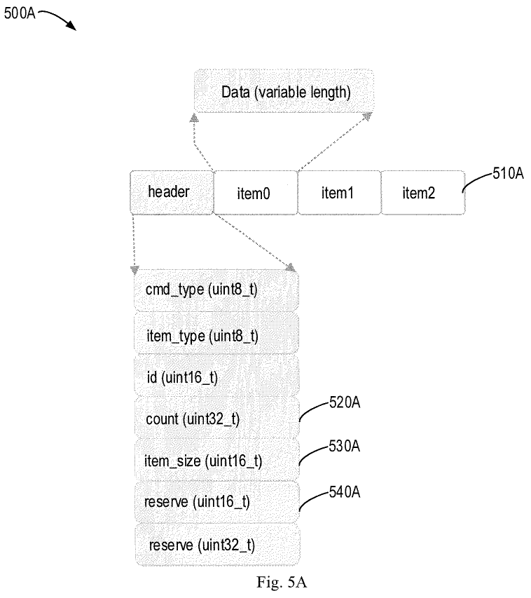

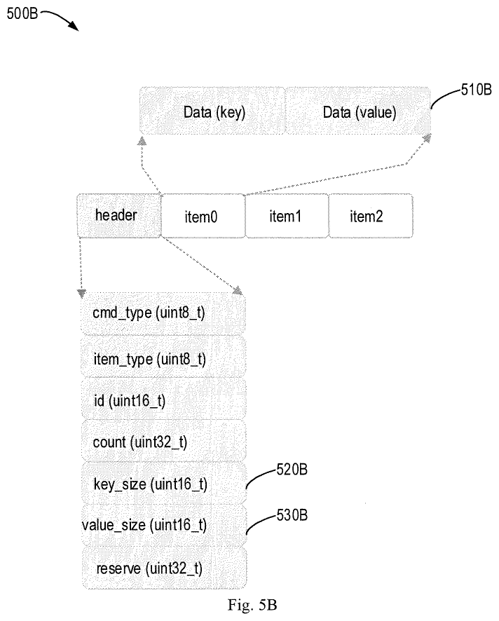

Memory data generated during the recovery task has various types of data structures, such as containers of standard library templates (STL), bitmaps, and so on. Therefore, when the memory data is copied from one node to another node for synchronization or task purposes, the data needs to be encoded on the node that sends the data, so that the data is converted from a format in the memory into a binary format for transmission. The node that receives the data then decodes the data and stores the data at a corresponding location in the memory of the node. Coding and decoding during data synchronization and task recovery will be described in more detail with reference to FIGS. 4A-4B and 5A-5C.

In use of the method 200, if the recovery task panics on an active node, the running of the recovery task can be resumed on the active node by using the task data that has been synchronized to the memory of the standby node without re-running from the beginning. In this way, the unavailable time of data of the storage system in the recovery mode is reduced, thereby improving user experiences.

Certain metadata issues may always panic the recovery task. In other words, current file system recovery software cannot handle anomalies associated with the metadata issues. In this case, a rolling panic will occur, that is, the resumed recovery task will panic again when the metadata problem is encountered. In some embodiments, the node 110 may use a counter to record the number of times of panics of the recovery task.

For example, if the number of times the recovery task panics on the node 110 exceeds a threshold (e.g., 3 times), the node 110 can terminate the recovery task. As another example, if the recovery task is resumed on the node 110 and has the number of times of panics for the same reason exceeding a threshold, the node 110 can terminate the recovery task.

In addition, the node 110 can send a warning about the number of times of panics exceeding the threshold to, for example, a terminal device used by a system administrator. And then, a software library used by the recovery task can be replaced to include functionality to handle corresponding anomalies. The recovery task can then continue with a new software library and standby task data on the node 120.

The recovery task for the file system can be divided into several stages, and the stages are dependent on each other. In each stage, the node 110 collects some task data and stores the collected task data in a memory so that the task data can be used in subsequent stages. In some embodiments, at the completion of each predetermined stage of the recovery task, the node 110 can synchronize stage task data associated with the predetermined stage in the memory of the node 110 to the memory of the node 120.

In other words, a plurality of save points may be set for the recovery task. When the recovery task on the node 110 has done some work, a save point can be created, and data of the save point can be synchronized to the memory of the node 120. When the recovery task on the node 110 panics for a certain reason, the recovery task can be resumed by retrieving the data of the save point from the node 120 at startup so that the recovery task can continue to run from the latest save point.

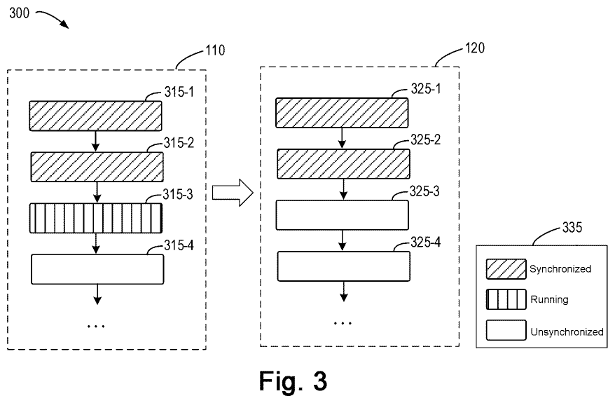

FIG. 3 shows an example schematic diagram 300 of synchronizing recovery task data in multiple stages according to some embodiments of the present disclosure. For ease of description, an example in FIG. 3 will be described with the node 110 in FIG. 1 as an active node that runs a recovery task and the node 120 as a standby node.

The left part of FIG. 3 shows a process of the recovery task for a file system, the recovery task running on the node 110. As shown in the figure, the recovery task has proceeded to stage 315-3 on the node 110. As a non-restrictive example, the recovery task for the file system can include scanning for different types of data mappings, recovery of state data, recovery of namespace, and so on. The specific stage division of the recovery task depends on implementations, and will not be limited in the embodiments of the present disclosure.

The right part of FIG. 3 shows a process of a standby task for the recovery task, the standby task running on the node 120. Stages 325-1 to 325-4 of the standby task correspond to stages 315-1 to 315-4 of the recovery task, respectively. At the completion of each stage in stages 315-1 to 315-4, the node 110 sends corresponding stage task data to the node 120 so that the node 120 stores the received task in its memory via the standby task. As those skilled in the art will understand, the number of stages of the task in the figure is only an example, and there may be fewer or more stages (i.e., more or fewer save points).

As shown in Reference FIG. 335, for stages 315-1 to 315-2 that have been completed,) corresponding task data has been synchronized to the node 120. For stage 315-3 that is uncompleted, corresponding task data has not been synchronized. If the recovery task panics on the node 110, the node 110 can obtain the task data that has been synchronized to the memory of the node 120. Then, based on the synchronized task data, the node 110 can resume the recovery task thereon to a stage corresponding to the synchronized task data. And then, the node 110 can continue to run the recovery task from this stage. In this example, the node 110 can obtain the synchronized data up to stage 315-2, resume its recovery task to a state at the completion of stage 315-2, and continue to run.

The node 110 can automatically obtain the synchronized data in response to the recovery task panicking, and attempt to resume the running of the task. In some cases, the resumed task may require some input additional adjustments to continue to run. In some such embodiments, if a timeout occurs during the recovery process, the node 110 can continue to run from the stage corresponding to the synchronized data based on a received user instruction.

As mentioned above, for example, when a stage of the recovery task is completed on the node 110, data having different structures, such as maps, vectors, lists, and bitmaps, is copied to the node 120. To support different types of data structures, data transmitted between the two nodes will be encoded into a unified format. When the recovery task for the file system is started, a data channel for transmitting the task data associated with the recovery task is established between the nodes 110 and 120. The encoded task data can then be transmitted through the data channel.

Before one node sends the task data to the other node for synchronization or recovery of the task, the node first encodes the task data from a data structure in the memory into a unified data structure for transmission. In some embodiments, the node 110 may send binary-encoded task data to the node 120. The task data is then decoded on the node 120 into a corresponding data structure used by memory data and is stored at a corresponding location in the memory of the node 120. Similarly, when the node 110 needs to resume the recovery task, the binary-encoded and synchronized task data can be sent from the node 120 to the node 110. The synchronized data is then decoded on the node 110 into a format previously stored in the memory of the node 110.

Reference will be made below to FIG. 4A which shows an example schematic diagram 400A of encoding and decoding processes when recovery task data is synchronized according to some embodiments of the present disclosure. For ease of description, an example in FIG. 4A will be described with the node 110 in FIG. 1 as an active node that runs a recovery task and the node 120 as a standby node. Also, in this example, list-type memory data is taken as an example. However, it should be understood that such encoding and decoding processes are also applicable to other types of memory data.

In the example shown in FIG. 4A, the nodes 110 and 120 include corresponding data encoding and decoding (DED) modules 410-1 and 410-2 respectively, and the DED modules 410-1 and 410-2 are configured to encode and decode data having different structures on corresponding nodes, respectively. In addition, when the node 110 starts a recovery task for a file system, the node 120 can start a standby task for the recovery task accordingly. For example, as mentioned above, the nodes 110 and 120 can run a process of the recovery task in active and standby modes, respectively. In response to this, a data channel 420 can be established between the nodes 110 and 120.

When the node 110 intends to synchronize memory data associated with the recovery task (for example, at the completion of a certain stage), it can encode the memory data into binary data using the DED module 410-1. For example, as shown in FIG. 4A, the node 110 can use the DED module 410-1 to encode in binary task data 405 having a list structure and add a header to the encoded data. The encoded task data 415 can then be sent to the node 120 via the data channel 420. In response to receiving the task data 415, the node 120 can decode the task data 415 using the DED module 410-2. Then, according to a location indicated in its header, the decoded data can be inserted into a corresponding list location in the memory of the node 120. It should be understood that the form in which the task data is stored in the memory of the node 120 depends on implementations. Moreover, the DED module 410-2 will be responsible for corresponding encoding and decoding to convert the task into appropriate formats for different purposes.

If the recovery task for the file system on the node 110 panics, the memory data associated with the recovery task in the memory of the node 110 will be lost. In this case, the node 110 can obtain the synchronized task data from the node 120 in order to resume the running of the recovery task on the node 110. In some embodiments, at the node 110, the node 120 can be caused to send binary-encoded and synchronized task data to the node 110. After receiving the synchronized task data, the node 110 can decode the binary-encoded and synchronized task data into a format in which the task data is previously stored in the memory of the node 110. In this way, the node 110 can use the restored memory data to continue the recovery task without re-running from the beginning.

FIG. 4B correspondingly shows an example schematic diagram 400B of encoding and decoding processes when a recovery task is resumed according to some embodiments of the present disclosure. In an example in FIG. 4B, for example, in response to a request from the node 110 for a standby of task data, the node 120 can obtain corresponding data in its memory using the DED module 410-2 and encode the data into binary data for transmission.

As shown in FIG. 4B, the node 110 can obtain data 425 that is previously synchronized to the node 110 using the DED module 410-1 and convert the data into encoded task data 435. The task data 435 can be similar to the task data 415 sent by the node 110 in the example in FIG. 4A. The task data 435 can then be sent to the node 120 via the data channel 420.

After receiving the task data 435, the node 110 decodes the task data 435 using the DED module 410-1 to obtain decoded task data 445. The task data 445 is in a format in which corresponding data is initially in the memory of the node 110, which is equivalent to the task data 405 in the example in FIG. 4A. In this way, the memory data associated with the recovery task on the node 110 can be restored. Then, the node 110 can continue to perform the function of the recovery task in the recovered memory state. As a result, the recovery task can continue from the latest save point, thereby avoiding the significant time and resource overhead required to re-execute the recovery task from the beginning.

In order to support the above encoding and decoding processes, the DED modules of the nodes 110 and 120 need to be able to encode and decode different types of task data, as well as identify instances of these types of data. In some embodiments, the node, when encoding the task data, adds a predefined structured header to the binary data to describe the data to assist in subsequent operations.

In some embodiments, the header may include a field that describes the type of a data content. As shown in the non-restrictive example in Table 1 below, the type (cmd_type) of the data content transmitted can be either command (cmd_type_command) or data (cmd_type_data), as will be described below in more detail in FIGS. 5A-5C. According to the type of the content of the encoded data, the node assigns a corresponding enumeration value to the field during encoding.

TABLE 1

```
enum cmd_type {
    cmd_type_command = 1,
    cmd_type_data = 2,
};
```

In some embodiments, the header may include a field that describes the type of a data structure in the memory. As shown in the non-restrictive example in Table 2 below, in one example implementation, the type of the data structure can be a list (data_type_list), a vector (data_type_vector), a mapping (data_type_map), a set (data_type_set), a pointer (data_type_sharedptr), and a bitmap (data_type_bitmap). According to the data structure of the encoded data, the node assigns a corresponding enumeration value to the field during encoding.

TABLE 2

```
enum item_type{
    data_type_list = 1,
    data_type_vector = 2,
    data_type_map = 3,
    data_type_set = 4,
    data_type_sharedptr = 5,
    data_type_bitmap = 6
};
```

In some embodiments, the header may further include an identifier (id). The field includes an identifier of an encoded data instance so that a receiving node can know where to insert the data instance after decoding.

Since the data content and the data structure are different in type, the binary-encoded structures thereof are also slightly different. FIGS. 5A-5C show binary-encoded structures of an example data type according to some embodiments of the present disclosure. It should be understood that these structures are shown only as non-restrictive examples. In other embodiments, variations of these structures and other structures may also be used.

Reference is made now to FIG. 5A. FIG. 5A shows an example binary-encoded structure 500A applicable to list data. A similar structure is also applicable to, for example, vector data. As shown in 510A, binary-encoded list data can include a header and a plurality of data items. In the header of a list, in addition to the above fields describing the types of the data content and the data structure and the instance id fields, a count field 520A and an item size (item_size) field 530A are further included.

A length of an item is variable in different lists. But in the same list, each of the items can have the same size. The size of the item is indicated by the item_size field 530A, so that a decoded node knows where an item begins and ends in a received packet. The count field 520A indicates the number of items included in the packet. For example, the number can depend on the length of the packet supported according to a communication protocol.

After receiving binary data encoded in this structure, the node first parses the header of the data. The node can then parse each of subsequent items based on the item_size field therein. Then, according to the type and id of the data, the node can insert the item into a corresponding data instance. Additionally, the binary structure of the list data can also include a reserve field 540A for future use.

Reference is made now to FIG. 5B. FIG. 5B shows an example binary-encoded structure 500 applicable to mapped data. Like the list data, the binary-encoded mapped data can include a header and a plurality of data items. In addition, the header of the list can similarly include a cmd_type field describing the type of contents, an item_type field describing the type of structures, an instance id field, a count field indicating the number of items, and a reserve field reserved for future use.

Unlike the list data, in a mapping, data is stored in the form of key-value pairs. Therefore, each data item of the mapping includes two fields that record a key and a value of the item respectively, as shown in reference numeral 510B. Correspondingly, the header of the mapped data includes two fields that indicate the size of the item, i.e., a key_size field 520B indicating the size of the key, and a value_size field indicating the size of the value.

After receiving binary data encoded in this structure, the node first parses the header of the data. The node can then parse each of subsequent items based on the key_size field and the value_size field therein. Then, according to the type and id of the data, the node can insert the item into a corresponding data instance.

During the recovery task, in order to store the collected data, the node 110 can allocate spaces in the memory. In addition, when it is determined that some memory data will no longer be used in subsequent operations, the node 110 can release corresponding memory spaces. In some embodiments, when task data for a certain stage is synchronized, the node 110 can further send a memory management command to the node 120. The memory management command indicates a space (first space) created and/or released in the memory of the node 110 by the recovery task in this stage. Then, based on the sent memory management command, the node 120 can be caused to create and/or release a space (second space) corresponding to the first space in its memory.

Reference is made now to FIG. 5C which shows an example binary-encoded structure 500 suitable for transmitting the above command. As shown in a reference numeral 510C, a binary-encoded command packet can include a header and parameters.

Memory management commands supported by a particular implementation are limited. Therefore, unlike the above data types, an enumeration value can be assigned to the id field 520C of the command depending on a specific command type to be sent. As shown in the non-restrictive example in Table 3 below, in one example implementation, the encoded commands can be a command for creating a memory pool (cmd_id_release_mem_pool), a command for releasing an instance (cmd_id_release_instance), or a command for creating a memory pool (cmd_id_release_instance).

TABLE 3

```
enum command_id {
    cmd_id_release_mem_pool = 1,
    cmd_id_release_instance = 2,
    cmd_id_create_mem_pool = 3
};
```

Each command has corresponding parameters for execution, and these parameters depend on the type of the command and are encoded behind the header. The header of the command further includes a param_size field 530C indicating the length of the parameters.

After receiving binary data encoded in this structure, the node first parses the header of the data. The node can then parse subsequent parameters based on the command type and the parameter length indicated therein, and use the parameters to execute corresponding commands on the node to create and/or release memory spaces.

FIG. 6 illustrates a schematic block diagram of a device 600 that may be used to implement embodiments of the present disclosure. The device 600 may be a device or apparatus as described in embodiments of the present disclosure, such as the node 110 and the node 120. As shown in FIG. 6, the device 600 includes a central processing unit (CPU) 601 that can perform various appropriate actions and processing according to computer program instructions stored in a read-only memory (ROM) 602 or computer program instructions loaded from a storage unit 608 to a random access memory (RAM) 603. Various programs and data required for the operation of the storage device 600 may also be stored in the RAM 603. The CPU 601, the ROM 602, and the RAM 603 are connected to each other through a bus 604. An input/output (I/O) interface 605 is also connected to the bus 604. Although not shown in FIG. 6, the device 600 may also include a co-processor.

A plurality of components in the device 600 are connected to the I/O interface 605, including: an input unit 606, such as a keyboard, a mouse, and the like; an output unit 607, such as various types of displays, speakers, and the like; the storage unit 608, such as a magnetic disk, a compact disc, and the like; and a communication unit 609, such as a network card, a modem, a wireless communication transceiver, and the like. The communication unit 609 allows the device 600 to exchange information/data with other devices via a computer network, such as the Internet, and/or various telecommunication networks.

The various methods or processes, such as method 200, described above may be performed by the processing unit 601. For example, in some embodiments, the methods may be implemented as a computer software program that is tangibly included in a machine-readable medium such as the storage unit 608. In some embodiments, part of or all the computer program can be loaded and/or installed onto the device 600 via the ROM 602 and/or the communication unit 609. When the computer program is loaded onto the RAM 603 and executed by the CPU 601, one or more steps or actions of the methods or processes described above can be performed.

In some embodiments, the methods and processes described above may be implemented as a computer program product. The computer program product may include a computer-readable storage medium on which computer-readable program instructions for performing various aspects of the present disclosure are loaded.

The computer-readable storage medium may be a tangible device that may retain and store instructions used by an instruction-executing device. For example, the computer-readable storage medium may be, but is not limited to, an electrical storage device, a magnetic storage device, an optical storage device, an electromagnetic storage device, a semiconductor storage device, or any suitable combination thereof. More specific examples (a non-exhaustive list) of the computer-readable storage medium include: a portable computer disk, a hard disk, a random access memory (RAM), a read-only memory (ROM), an erasable programmable read-only memory (EPROM or flash memory), a static random access memory (SRAM), a portable compact disc read-only memory (CD-ROM), a digital versatile disc (DVD), a memory stick, a floppy disk, a mechanical coding device, for example, a punch card or a raised structure in a groove with instructions stored thereon, and any suitable combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from a computer-readable storage medium to various computing/processing devices, or downloaded to an external computer or external storage device via a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

The computer program instructions for performing the operations of the present disclosure may be assembly instructions, Instruction Set Architecture (ISA) instructions, machine instructions, machine-related instructions, microcode, firmware instructions, status setting data, or source code or object code written in any combination of one or more programming languages, including object-oriented programming languages as well as conventional procedural programming languages. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer can be connected to a user computer through any kind of networks, including a local area network (LAN) or a wide area network (WAN), or can be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions so as to implement various aspects of the present disclosure.

These computer-readable program instructions may be provided to a processing unit of a general-purpose computer, a special-purpose computer, or a further programmable data processing apparatus, thereby producing a machine, such that these instructions, when executed by the processing unit of the computer or the further programmable data processing apparatus, produce means (e.g., specialized circuitry) for implementing functions/actions specified in one or more blocks in the flow charts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored includes an article of manufacture that includes instructions that implement various aspects of the functions/actions specified in one or more blocks in the flow charts and/or block diagrams.

The computer-readable program instructions may also be loaded to a computer, other programmable data processing apparatuses, or other devices, so that a series of operating steps may be executed on the computer, the other programmable data processing apparatuses, or the other devices to produce a computer-implemented process, such that the instructions executed on the computer, the other programmable data processing apparatuses, or the other devices may implement the functions/actions specified in one or more blocks in the flow charts and/or block diagrams.

The flow charts and block diagrams in the drawings illustrate the architectures, functions, and operations of possible implementations of the devices, methods, and computer program products according to various embodiments of the present disclosure. In this regard, each block in the flow charts or block diagrams may represent a module, a program segment, or part of an instruction, and the module, program segment, or part of an instruction includes one or more executable instructions for implementing specified logical functions. In some alternative implementations, functions denoted in the blocks may also occur in an order different from that denoted in the accompanying drawings. For example, two successive blocks may in fact be executed substantially concurrently, and sometimes they may also be executed in a reverse order, depending on the functions involved. It should be further noted that each block in the block diagrams and/or flow charts as well as a combination of blocks in the block diagrams and/or flow charts may be implemented using a special-purpose hardware-based system that executes specified functions or actions, or using a combination of special-purpose hardware and computer instructions.

The embodiments of the present disclosure have been described above. The foregoing description is illustrative rather than exhaustive, and is not limited to the embodiments disclosed. Numerous modifications and alterations are apparent to those of ordinary skill in the art without departing from the scope and spirit of the illustrated embodiments. The selection of terms as used herein is intended to best explain the principles and practical applications of the various embodiments or the technical improvements to technologies on the market, or to enable other people of ordinary skill in the art to understand the various embodiments disclosed herein.

1. A file system recovery method, comprising:
running a recovery task for a file system on a first node, wherein data of the file system is stored in a storage device that is accessible via the first node or a second node;
synchronizing task data associated with the recovery task in a memory of the first node to a memory of the second node during the running of the recovery task; and
in response to the recovery task panicking on the first node, resuming the running of the recovery task on the first node by using the task data that has been synchronized to the memory of the second node.

2. The method according to claim 1, wherein synchronizing the task data to a memory of the second node comprises:
allowing the second node to receive the task data from the first node via a standby task running on the second node; and
storing the received task data at a corresponding location in a memory of the second node via the standby task.

3. The method according to claim 1, wherein synchronizing the task data to a memory of the second node comprises:
sending the binary-encoded task data from the first node to the second node;
decoding the binary-encoded task data on the second node; and
storing the decoded task data at a corresponding location in a memory of the second node.

4. The method according to claim 3, wherein resuming the running of the recovery task on the first node comprises:
sending the binary-encoded and synchronized task data from the second node to the first node; and
decoding, on the first node, the binary-encoded and synchronized task data into a format in which the task data is stored in the memory of the first node.

5. The method according to claim 1, further comprising:
in response to the recovery task resumed on the first node and having the number of times of panics for the same reason exceeding a threshold, terminating the recovery task.

6. The method according to claim 1, wherein synchronizing the task data to a memory of the second node comprises:
in response to completion of a predetermined stage of the recovery task, synchronizing stage task data associated with the predetermined stage in the memory of the first node to the memory of the second node.

7. The method according to claim 6, wherein synchronizing the stage task data to the memory of the second node comprises:
sending a memory management command from the first node to the second node, the memory management command indicating a first space released in the memory of the first node by the recovery task in the predetermined stage; and
based on the memory management command, releasing a second space corresponding to the first space in the memory of the second node.

8. The method according to claim 6, further comprising:
in response to the recovery task panicking on the first node, obtaining the task data that has been synchronized to the memory of the second node;
resuming, on the first node, the recovery task to a stage corresponding to the synchronized task data based on the synchronized task data; and
continuing to run the recovery task from the stage on the first node.

9. An electronic device, comprising:
a processor; and
a memory coupled to the processor, wherein the memory has instructions stored therein, and the instructions, when executed by the processor, cause the device to perform actions comprising:
running a recovery task for a file system on a first node, wherein data of the file system is stored in a storage device that is accessible via the first node or a second node;
synchronizing task data associated with the recovery task in a memory of the first node to a memory of the second node during the running of the recovery task; and
in response to the recovery task panicking on the first node, resuming the running of the recovery task on the first node by using the task data that has been synchronized to the memory of the second node.

10. The device according to claim 9, wherein synchronizing the task data to a memory of the second node comprises:
allowing the second node to receive the task data from the first node via a standby task running on the second node; and
storing the received task data at a corresponding location in a memory of the second node via the standby task.

11. The device according to claim 9, wherein synchronizing the task data to a memory of the second node comprises:
sending the binary-encoded task data from the first node to the second node;
decoding the binary-encoded task data on the second node; and
storing the decoded task data at a corresponding location in a memory of the second node.

12. The device according to claim 11, wherein resuming the running of the recovery task on the first node comprises:
sending the binary-encoded and synchronized task data from the second node to the first node; and
decoding, on the first node, the binary-encoded and synchronized task data into a format in which the task data is stored in the memory of the first node.

13. The device according to claim 9, wherein the actions further comprise:
in response to the recovery task resumed on the first node and having the number of times of panics for the same reason exceeding a threshold, terminating the recovery task.

14. The device according to claim 9, wherein synchronizing the task data to a memory of the second node comprises:
in response to completion of a predetermined stage of the recovery task, synchronizing stage task data associated with the predetermined stage in the memory of the first node to the memory of the second node.

15. The device according to claim 14, wherein synchronizing the stage task data to the memory of the second node comprises:
sending a memory management command from the first node to the second node, the memory management command indicating a first space released in the memory of the first node by the recovery task in the predetermined stage; and
based on the memory management command, releasing a second space corresponding to the first space in the memory of the second node.

16. The device according to claim 14, wherein the actions further comprise:
in response to the recovery task panicking on the first node, obtaining the task data that has been synchronized to the memory of the second node;
resuming, on the first node, the recovery task to a stage corresponding to the synchronized task data based on the synchronized task data; and
continuing to run the recovery task from the stage on the first node.

17. A computer program product tangibly stored on a computer-readable medium and comprising machine-executable instructions, wherein the machine-executable instructions, when executed, cause a machine to perform actions comprising:
running a recovery task for a file system on a first node, wherein data of the file system is stored in a storage device that is accessible via the first node or a second node;
synchronizing task data associated with the recovery task in a memory of the first node to a memory of the second node during the running of the recovery task; and
in response to the recovery task panicking on the first node, resuming the running of the recovery task on the first node by using the task data that has been synchronized to the memory of the second node.

18. The computer program product according to claim 17, wherein synchronizing the task data to a memory of the second node comprises:
allowing the second node to receive the task data from the first node via a standby task running on the second node; and
storing the received task data at a corresponding location in a memory of the second node via the standby task.

19. The computer program product according to claim 17, wherein the actions further comprise:
sending the binary-encoded task data from the first node to the second node;
decoding the binary-encoded task data on the second node; and
storing the decoded task data at a corresponding location in a memory of the second node.

20. The computer program product according to claim 17, wherein synchronizing the task data to a memory of the second node comprises:
in response to completion of a predetermined stage of the recovery task, synchronizing stage task data associated with the predetermined stage in the memory of the first node to the memory of the second node.
